(19) United States
(12) Patent Application Publication
(10) Pub. No.: US 2023/0239254 A1
(43) Pub. Date: Jul. 27, 2023

(54) Panel-Mounted Network Switch For An Ingress-Protected Enclosure

(71) Applicant: ABB Schweiz AG, Baden (CH)

(72) Inventor: Marcus Wadstein, Västerâs (SE)

(21) Appl. No.: 18/001,307

(22) PCT Filed: Jun. 17, 2020
(86) PCT No.: PCT/EP2020/066833

§ 371 Date: Dec. 9, 2022

(51) Int. Cl. H04L 49/40; H04Q 1/02; H04Q 1/04

(52) U.S. Cl. CPC H04L 49/40; H04Q 1/025; H04Q 1/04; H04Q 1/13

(57) ABSTRACT

A network switch suitable to form part of an ingress-protected enclosure, the network switch including: an inward-facing cover having at least one inward-facing port for connecting a networked device; an outward-facing cover having multiple outward-facing ports for connecting networked devices; and processing circuitry configured to establish network connections among the inward-facing and outward-facing ports.

### TECHNICAL FIELD

The present disclosure relates to the field of network hardware for demanding environments. It relates in particular to a network switch suitable for forming part of an ingress-protected enclosure.

### BACKGROUND

The market is moving towards high-speed Ethernet-based bus communication, wherein the number of devices requiring a wired network connection with high signal integrity is increasing. Parallel to this, there is a desire to reduce the number of hardware components needed to achieve a particular network topology, which may mean that star topologies are preferred over branched networks with distributed connectors, switches and/or routers. This desire is especially pronounced in demanding environments, where dedicated enclosures are necessary to protect the network hardware from humidity, dust, gaseous or airborne corrosives, unauthorized tampering and the like.

To illustrate, FIG. 1 shows a conventional internal Ethernet switch 100 installed together with a main computer 170 on a controller door 152 of an ingress-protected cabinet 150. The main computer 170 and the internal Ethernet switch 100 are connected by an internal Ethernet cable 163. Extending from the internal network switch 100, a bundle 161 of multiple Ethernet cables passes through the cabinet's 150 interior 151, exits via a cable gland 162 on an installation panel 153 and continues towards external networked devices (not shown) outside the cabinet 150. The cable gland 162, of a multi-pole type, allows the bundle 161 to exit the cabinet 150 without compromising its ingress protection. Without any need to arrange branching points, there may be as many separately connected external networked devices as there are Ethernet cables in the bundle 161.

A drawback with the setup shown in FIG. 1 is that the network user (e.g., owner of the external networked devices) will need to access the internal Ethernet switch 100 whenever a new connection is to be added or an existing connection is to be inspected or repaired; the network user will therefore require the permission of the network supplier (e.g., owner of the main computer 170) to enter the cabinet 150 frequently, which may compromise guaranteed signal integrity or other safety aspects. For example, it cannot be avoided that the network user will gain access to the network supplier's internal Ethernet cable 163 as well. The bundle 161 moreover occupies precious space inside the cabinet 150 and may obstruct wanted cooling air flows.

Another known setup is depicted in FIG. 2, where the network connections extend from an external Ethernet switch 200 located outside the ingress-protected cabinet 150. The connection between the external Ethernet switch 200 and the main computer 170 is then achieved using an external Ethernet cable 164, which leaves the cabinet 150 via a single-pole cable gland 162. The external Ethernet cable 164 need not consist of a bundle of cables but may be a single-pole cable. With this setup, the network user has immediate access to the Ethernet switch 200 and can reconfigure the network topology without difficulty. This user-side convenience is achieved at the cost that both the external Ethernet cable 164 and the external Ethernet switch 200 must be ingress-protected or ‘rugged’ in the sense they must withstand the environment outside the cabinet 150 without further protection.

CN202095192U discloses an industrial Ethernet switch which is completely dustproof, waterproof, and thereby potentially suitable for the use case illustrated in FIG. 2.

There is a desire to provide a network switch that eliminates at least some of these drawbacks.

### SUMMARY

One objective is to make available a network switch for connecting a networked device in an ingress-protected enclosure and a plurality of networked devices outside this enclosure. A particular objective is to reduce the requirement for ingress protection of the network switch itself and/or of the cables used with the network switch. A further objective is to make available an ingress-protected enclosure that includes such a network switch.

These and other objectives are achieved by the invention defined by claim 1. The dependent claims are directed to advantageous embodiments.

There is provided a network switch suitable to form part of an ingress-protected enclosure. The network switch comprises an inward-facing cover having at least one inward-facing port for connecting a networked device, an outward-facing cover having multiple outward-facing ports for connecting networked devices, and processing circuitry configured to establish network connections among the inward-facing and outward-facing ports.

A network switch with these characteristics allows an operator to reconfigure the connections towards the networked devices outside the ingress-protected enclosure without being authorized to enter the enclosure. The interior of the enclosure is not cluttered by Ethernet cables towards multiple external networked devices. The inventive network switch is furthermore advantageous in that it requires ingress protection only for such connected components or equipment (e.g., cables) that is located outside the ingress-protected enclosure.

As used herein, a “ingress-protected enclosure” means an enclosure, including a multi-component casing or shielding, which restricts entry of solid particles and/or liquids. An ingress-protected enclosure may furthermore be composed of building dividers (e.g., wall, floor, ceiling), machinery, electric connectors or cables, installation panels, gaskets, seals, joints, bushings, grommets, lead-ins and the like. There exist standardized and systematic approaches to ingress protection, as well as testing and grading of ingress-protected equipment or enclosures. The IP Codes defined in IEC 60529 and EN 60529 constitute one example.

In this disclosure, the qualifiers “inward-facing” and “outward-facing” refer to the ingress-protected enclosure, e.g., located towards the interior of the enclosure and away from the enclosure, respectively. To “establish network connections”, furthermore, includes providing connectivity to a networked device which is (physically) connected to an inward- or outward-facing port of the network switch. The connectivity may include an ability to transmit data to or receive data from other devices in the same network. In addition to an established physical connection, connectivity may require assigning or confirming a network address of the networked device.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, on which:

FIG. 1 is a schematic illustration of a first prior art setup for connecting one internal and multiple external networked devices, where a network switch is arranged inside an ingress-protected enclosure;

FIG. 2 shows a second prior art setup addressing the same problem, in which the network switch is arranged outside the ingress-protected enclosure;

FIG. 3 shows a setup including a network switch according to an embodiment of the invention, which is mounted at the boundary of the ingress-protected enclosure;

FIG. 4 includes a rear (outward-facing), front (inward-facing), side and perspective view of a network switch according to an embodiment of the invention;

FIG. 5 is an exploded view of the network switch; and

FIG. 6 shows the network switch with connectors and a portion of the ingress-protected enclosure as seen from the outside (FIG. 6A) and the inside (FIG. 6B).

### DETAILED DESCRIPTION

The present invention will now be described more fully with reference to the accompanying drawings, on which certain embodiments are shown. The invention may, however, be embodied in many different forms and the disclosed embodiments should not be construed as limiting; rather, these embodiments are provided by way of example so that this disclosure will be thorough and complete, and to fully convey the scope of all aspects of invention to those skilled in the art. Like numbers refer to like elements throughout the description.

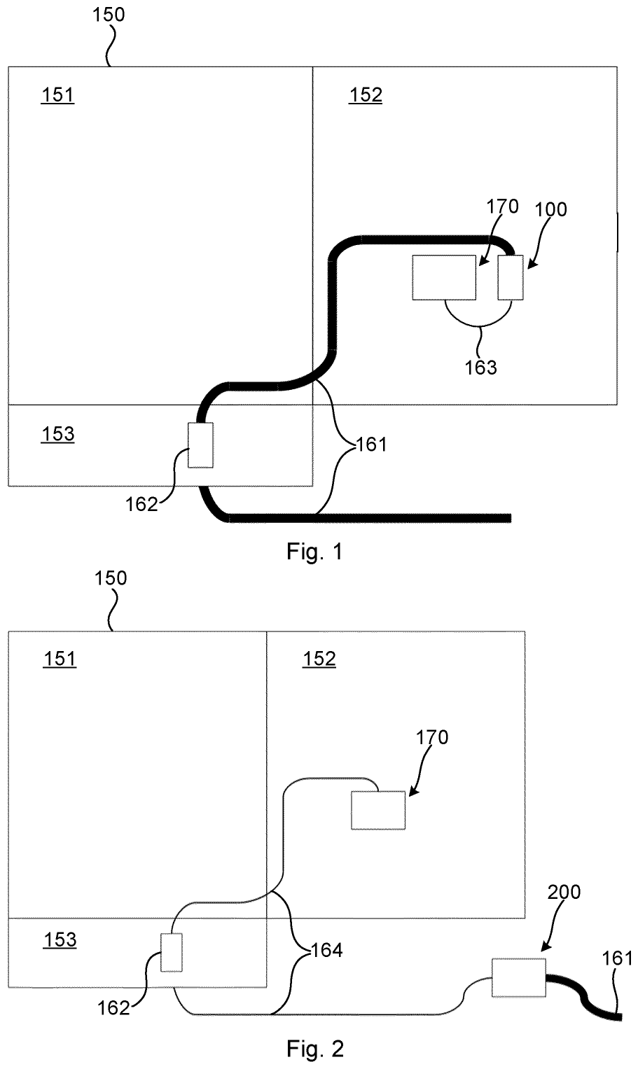

FIGS. 1 and 2 are schematic illustrations of network setups which have been discussed above as technical background of the invention.

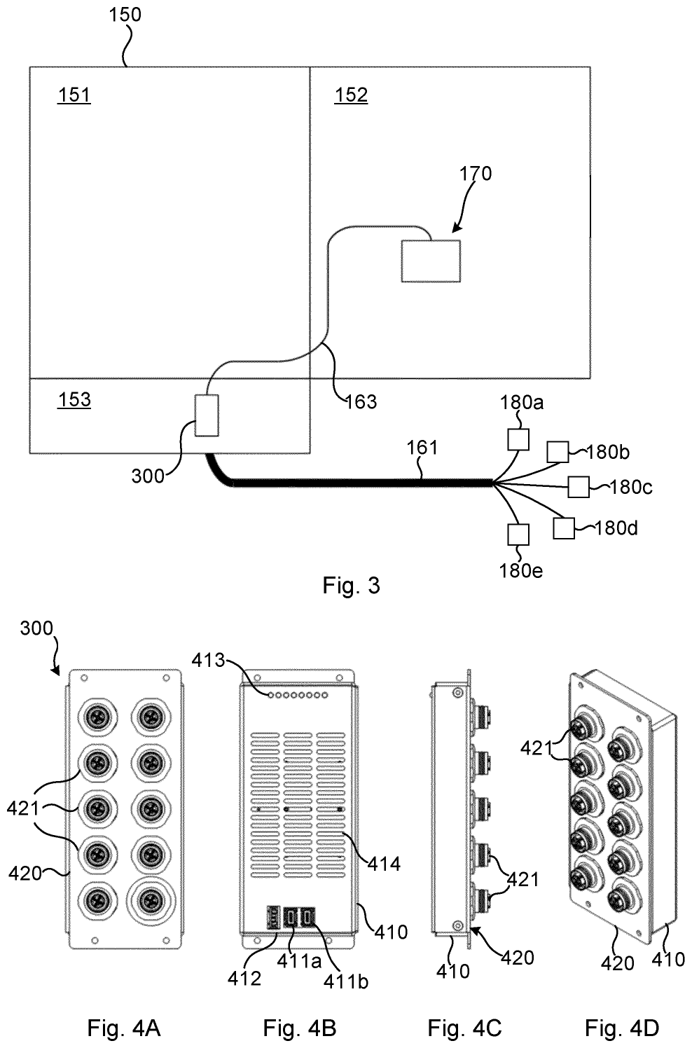

FIG. 3 shows a network setup where a network switch 300 is mounted in an installation panel 153 of an ingress-protected cabinet 150, preferably in such manner that the combination of the cabinet 150 and the network switch 300 form an ingress-protected enclosure. The cabinet 150 further defines an inspection aperture 152, such as an openable cabinet door or hatch, which in its closed position satisfies the same level of ingress protection as the cabinet 150. While the inspection aperture 152 is provided in a front wall of the cabinet 150, the installation panel 153 may be located in a rear or side wall, or even in a roof or floor of the cabinet 150. As an alternative to a cabinet, an appropriately sealed room of a building may constitute or make up a portion of the ingress-protected enclosure.

From an inward-facing port of the network switch 300, an internal network cable 163 when connected extends to a computer 170 located inside the cabinet 150. The internal network cable 163 is of a type that withstands the (relatively favorable) conditions prevailing inside the cabinet 150. It need not withstand the environment outside the cabinet 150, which would amount to costly oversizing, with secondary drawbacks such as increased diameter and stiffness etc. of the cable 163. The network switch 300 has a plurality of outward-facing ports. When these are in use, a number of external network cables leave towards networked devices 180 outside the cabinet 150. At least for a portion of the path, the external network cables may be combined into a permanent or temporary bundle 161. Further away from the network switch 300, the bundle 161 may be split to allow individual cables to reach the respective networked devices 180. It is recalled that no active or passive network equipment is needed to split off a network cable from the bundle 161.

A possible implementation of the network switch 300 according to an embodiment of the invention is illustrated in FIG. 4.

FIG. 4A is a rear view of the network switch 300, showing mainly the outward-facing cover 420 and ten outward-facing ports 421 for connecting up to ten networked devices via respective cables. The specific type of outward-facing ports 421 may be chosen in view of the expected conditions in the environment outside the cabinet 150; for example, one may use rugged-Ethernet connectors, M12 connectors, push-pull connectors, heavy-duty connectors or a combination of these. The outward-facing cover 420 itself may for example satisfy at least IP 54 under IEC 60529.

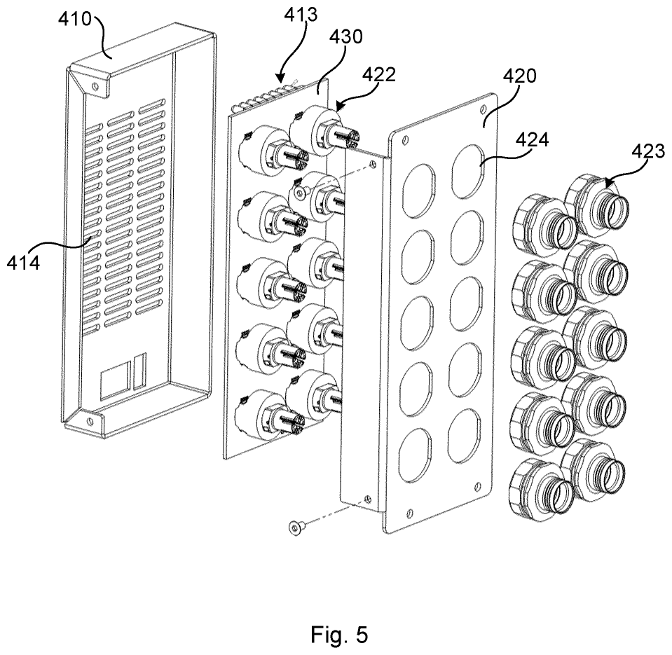

FIG. 4B is a front view 410 of the network switch 300. A front surface of an inward-facing cover 410 is visible. In the shown embodiment, where the network switch 300 is recessed into a wall of the cabinet 150, the inward-facing cover 410 may further comprise lateral surfaces, which are shown more clearly in FIG. 5. The inward-facing cover 410 may be of metal. In some embodiments, it has a lower ingress-protection class than the outward-facing cover 420, such as at most IP 20.

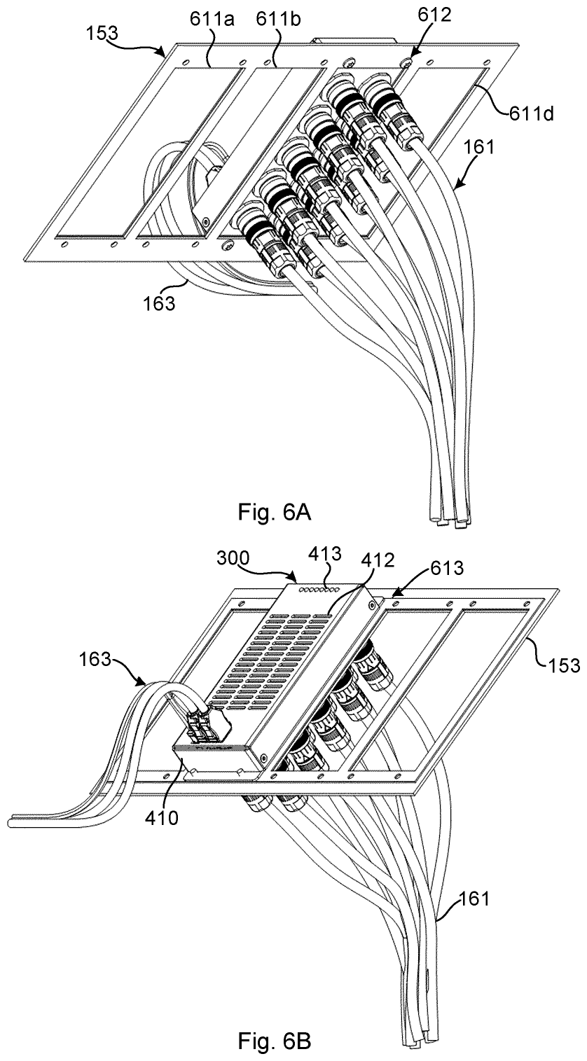

The inward-facing cover 410 defines ports and/or connectors. In the example shown in FIG. 4, where the network switch 300 is powered from the inside of the cabinet 150, these include a network input port 411a, a network output port 411b and a power supply connector 412. The network ports 411a, 411b may be RJ45, iX, Mini-IO ports or of a similar type. The power supply connector 412 preferably has a locking mechanism that withstands normal vibrations, shocks and the like without disconnecting. The onward network line leaving from the network ports 411a, 411b may be an internal-type network cable 163 (see FIG. 6), of the same or similar ingress-protection class as the inward-facing cover 410 itself. The inward-facing cover 410 further defines apertures for ventilation 414 and for showing a variable visual indication 413. The visual indication 413 may be provided by a plurality of illuminable light sources, and may be used to indicate a condition or operational status of the network switch 300. In particular, an operator accessing the cabinet 150 through the inspection aperture 152 may contemporaneously inspect the computer 170 and, through the interior of the cabinet 150, monitor diagnostic messages displayed on the visual indication 413 of the network switch 300.

The side view in FIG. 4C and perspective view in FIG. 4D show the recessed shape of the network switch 300. More precisely, the outward-facing cover 420 is slightly taller than the inward-facing cover 410 and thereby forms top and bottom mounting shoulders. In a mounted position of the network switch 300, the outward-facing cover 420 rests directly or indirectly (e.g., without or with a sealing gasket) against the outside or inside of a wall of the cabinet 150 or an installation panel provided in said wall.

The exploded view of the network switch 300 in FIG. 5 shows that it includes a circuit board 430, which carries processing circuitry (not shown) configured to perform network switching operations. For example, the processing circuitry may be configured to perform switching in an Ethernet network. In some embodiments, the processing circuitry is configured to operate on Open Systems Interconnection (OSI) layer 2 or higher. The circuit board 430 may be a printed circuit board (PCB) or a surface-mounted circuit board. A connector insert 422 of each outward-facing port 421 may be mounted on the circuit board 430. The connector insert 422, which may hold electronic circuitry, extends outwardly from the circuit board 430 through a corresponding aperture 424 in the outward-facing cover 420, where it is fitted to a connector base 423. The connector base 423 enables physical connection of a network cable towards an external networked device 180. When the connector insert 422 and connector base 423 are fitted together, the circuit board 430 is retained inside the network switch 300, which is also sealed off against the environment outside the cabinet 150 (e.g., up to IP 54). The sealing at the aperture 424, which may be achieved by a washer, gasket, bushing or the like, is all the more important as the inward-facing cover 410 in this embodiment is provided with ventilation apertures 414, which would allow contamination to pass into the interior of the cabinet 150.

The inward-facing 410 and outward-facing 420 covers may be joined by a non-permanent joint, such as a screw connection or screw joint. FIG. 5 illustrates how such a screw connection can be provided by letting the outward-facing cover 420 continue laterally to form flaps, which are bent at right angles to extend inwardly and are provided with a suitable number of screw holes aligning with holes on lateral faces of the inward-facing cover 410. The joining of the covers 410, 420 shall fulfil the same or similar ingress-protection class as the inward-facing cover 410 itself. For this purpose, an optional sealing gasket may be interposed between the covers 410, 420. The covers 410, 420 can be separated by undoing the screws. In some embodiments, the screws are deliberately made inaccessible when the network switch 300 is in a mounted position, i.e., when it forms part of the ingress-protected enclosure. For example, the screwheads may be covered by prongs on the inside of the enclosure wall.

FIG. 6 shows the network switch 300 when mounted in a portion of the ingress-protected enclosure and has connected to it inward network cables 163 and a bundle 161 of outward network cables. FIG. 6A is a view from the outside and FIG. 6B from the inside. In the example depicted, the ingress-protected enclosure comprises a cabinet 150 (see FIG. 1) with an installation panel 153, which may be attached to or constitute an integral part of the cabinet's 150 outer walls. The installation panel 153 defines one or more holes 611, which are sized to accommodate the network switch 300 and devices with compatible dimensions and provided with screw holes. For the integrity of the enclosure, any supernumerary holes 611 of the installation panel 153 are to be covered with blinds, plates or the like. In variations of the described embodiment, the network switch 300 may be mounted directly into a wall of the cabinet 150, that is, without the intermediary installation panel 153.

Mounting of the network switch 300 in the installation panel 153 may proceed as follows: a gasket 613 surrounding one or more of the holes 611 is placed on the inside, the network switch 300 is placed on top of the gasket 613 in such manner that the screw holes on the top and bottom mounting shoulders align with the screw holes of the respective hole 611 of the installation panel 153, whereupon bolts or screws 612 are inserted and tightened from the outside. Preferably, for convenience of assembly, the screw holes on the mounting shoulders are either threaded or provided with an inside cage nut, which engages with the screw or bolt. The gasket 613 may be planar or rounded; the outward-facing cover 420 or the installation panel 153 may include a shallow notch for accommodating a gasket 613 of rounded shape.

The aspects of the present invention have mainly been described with reference to a few embodiments. However, as is readily appreciated by a person skilled in the art, other embodiments than the ones disclosed above are equally possible within the scope of the invention, as defined by the appended patent claims.

1. A network switch suitable to form part of an ingress-protected enclosure, the network switch comprising:
an inward-facing cover having at least one inward-facing port for connecting a networked device;
an outward-facing cover having multiple outward-facing ports for connecting networked devices; and
processing circuitry configured to establish network connections among the inward-facing and outward-facing ports.

2. The network switch of claim 1, which is suitable for mounting in a hole of an installation panel of the ingress-protected enclosure.

3. The network switch of claim 2, wherein the network switch, in a mounted state, is recessed into said installation panel.

4. The network switch of claim 2, wherein the outward-facing cover is arranged to accommodate a gasket between itself and the installation panel of the ingress-protected enclosure.

5. The network switch of claim 2, wherein, in an unmounted state of the network switch, the inward-facing and outward-facing covers are directly joinable, such as by a screw connection.

6. The network switch of claim 1, wherein the outward-facing cover satisfies IP 54 or higher.

7. The network switch of claim 1, wherein the outward-facing ports extend outwardly from a circuit board carrying the processing circuitry.

8. The network switch of claim 1, wherein the outward-facing ports are at least one of: rugged-Ethernet connectors, M12 connectors, push-pull connectors, heavy-duty connectors.

9. The network switch of claim 1, wherein the inward-facing cover has one or more of:
a variable visual indicator;
a power supply connector;
a ventilation aperture.

10. The network switch of claim 1, wherein the at least one inward-facing port comprises a network input port and a network output port.

11. The network switch of claim 1, wherein the processing circuitry is configured to operate on OSI layer 2 or higher.

12. The network switch of claim 1, which is an Ethernet switch.

13. An ingress-protected enclosure, comprising:
a network switch including:
an inward-facing cover having at least one inward-facing port for connecting a networked device;
an outward-facing cover having multiple outward-facing ports for connecting networked devices; and
processing circuitry configured to establish network connections among the inward-facing and outward-facing ports; and
an inspection aperture.

14. The ingress-protected enclosure of claim 13, wherein the network switch and the inspection aperture are provided in two different walls of the ingress-protected enclosure.

15. The ingress-protected enclosure of claim 13, which is a cabinet.

16. The network switch of claim 3, wherein the outward-facing cover is arranged to accommodate a gasket between itself and the installation panel of the ingress-protected enclosure.

17. The network switch of claim 3, wherein, in an unmounted state of the network switch, the inward-facing and outward-facing covers are directly joinable, such as by a screw connection.

18. The network switch of claim 2, wherein the outward-facing cover satisfies IP 54 or higher.

19. The network switch of claim 2, wherein the outward-facing ports extend outwardly from a circuit board carrying the processing circuitry.
